(19) United States
(12) Patent Application Publication
(10) Pub. No.: US 2023/0117556 A1
(43) Pub. Date: Apr. 20, 2023

(54) SYSTEM AND METHOD FOR PERFORMANCE MONITORING OF PRODUCT MANUFACTURING MACHINES

(71) Applicant: Winpak Lane, Inc., Rialto, CA (US)

(72) Inventors: Luis Torres, Mentone, CA (US); David Garcia, Victorville, CA (US); Steven Davis, Amelia, OH (US)

(21) Appl. No.: 17/951,015

(22) Filed: Sep. 22, 2022

Related U.S. Application Data
(60) Provisional application No. 63/247,302, filed on Sep. 22, 2021.

(51) Int. Cl. G05B 19/418

(52) U.S. Cl. CPC G05B 19/41875; G05B 19/4184

(57) ABSTRACT

An apparatus includes a machine for manufacturing a product from one or more input materials, with the machine including at least a sensor, a control panel, and a switch through which operation of the machine can be stopped. The apparatus further includes a physical display device and a computing device communicationally coupled to both the machine and the physical display device, the computing device causing the physical display device to display user interface that has a first portion displaying an availability indicator, a second portion displaying a performance indicator and a third portion displaying a quality indicator. The computing device can determine the availability indicator, the performance indicator and the quality indicator from data received from the machine and from the operator thereof. Restarting of the machine can be prevented until a reason for the machine's stoppage is received, with the reason being optionally computer-validated to enable restart.

### CROSS-REFERENCE TO RELATED APPLICATION

This application claims priority to U.S. patent application Ser. No. 63/247,302, filed on Sep. 22, 2021, and entitled “SYSTEM AND METHOD FOR PERFORMANCE MONITORING OF POUCH MACHINE”, the entirety of which is hereby incorporated by reference in its entirety for all that it teaches and suggests.

### BACKGROUND OF THE DISCLOSURE

### 1. Field of the Disclosure

The disclosure relates in general to monitoring the performance of product manufacturing machines, and more particularly, to generating user interfaces visually displaying determined performance metrics. Such performance monitoring is disclosed herein for a vertical form fill sealing machine or pouch machine; however, such performance monitoring can be applied to any type of product manufacturing machine for which it is desirable to monitor performance, such as to distinguish between performance degradation due to machine design versus performance degradation due to improper or inefficient usage by an end user or other customer of the machine manufacturer.

### 2. Background Art

The pouch machine was developed in the 1930's to service the candy industry. The pouch machine forms plastic bags or pouches out of a flat roll of film. At the same time as forming the pouches, the pouch machine fills the pouches with product and seals the filled pouches. The pouch machine can fill the pouches with either a solid or liquid product. The flat roll of film typically has identification information on an outside of the film typically indicating both a type of product inside the pouches and a manufacturer of the product. Typically, a horizontal sealing bar forms a bottom seal for the pouches by clamping across a bottom edge of a tube used to fill the pouches, and heating this bottom edge. The pouches travel down through the pouch machine to repeat this process. A cutter is used to separate the pouches once fully sealed.

### SUMMARY OF THE DISCLOSURE

The disclosure is directed to an apparatus comprised of a machine for manufacturing product from one or more input materials, a physical display device and a performance monitor computing device which is configured to receive data and inputs, generate performance analytics based on the received data and inputs, and generate a user interface, such as on the physical display device, with the user interface graphically illustrating various aspects of the performance analytics.

In at least one configuration, the machine is a pouch machine.

The disclosure is also directed to a graphical user interface, physically generated on a physical display device by a computing device that is communicationally coupled to the physical display device, with the user interface graphically illustrating various aspects of the performance analytics.

In at least one configuration, the various aspects of the performance analytics that are illustrated by the graphical user interface include an availability indicator, a performance indicator, and a quality indicator.

The disclosure is also directed to a method of controlling a machine, the method including detecting that the machine was stopped and preventing restarting of the machine until a reason for the stoppage is provided.

In at least one configuration, the method is performed by a computing device communicationally coupled to the machine.

### BRIEF DESCRIPTION OF THE DRAWINGS

The disclosure will now be described with reference to the drawings wherein:

FIG. 1 illustrates an example apparatus, comprising an example machine, in the form of a pouch machine, and further comprising an example physical display device and an example performance monitor computing device, in accordance with at least one configuration disclosed herein;

FIG. 2 illustrates a block diagram of examples of performance monitoring components executed by the performance monitor computing device, in accordance with at least one configuration disclosed herein;

FIG. 3 illustrates an example networked system including the machine shown in FIG. 1, in accordance with at least one configuration disclosed herein;

FIG. 4 illustrates an example Graphic User Interface (GUI) for displaying overall equipment effectiveness, in accordance with at least one configuration disclosed herein;

FIG. 5 illustrates an example flow diagram for responding to user stoppage of the machine, in accordance with at least one configuration disclosed herein;

FIG. 6 illustrates an example Graphic User Interface (GUI) for enabling a user to specify a reason for stopping the machine, in accordance with at least one configuration disclosed herein; and

FIG. 7 illustrates an exemplary general-purpose computing device that can be used to implement the performance monitor shown in FIG. 1, in accordance with at least one configuration disclosed herein.

### DETAILED DESCRIPTION OF THE DISCLOSURE

While this disclosure is susceptible of embodiment in many different forms, there is shown in the drawings and described herein in detail a specific embodiment(s) with the understanding that the present disclosure is to be considered as an exemplification and is not intended to be limited to the embodiment(s) illustrated.

It will be understood that like or analogous elements and/or components, referred to herein, may be identified throughout the drawings by like reference characters. In addition, it will be understood that the drawings are merely schematic representations of the invention, and some of the components may have been distorted from actual scale for purposes of pictorial clarity.

The inventors of this disclosure came to appreciate that repetitive machine apparatuses have an optimal up time or a time at which the repetitive machine apparatus is being operated. However, such optimal up time is subject to interrupts, such as an operator break (e.g., lunch, scheduled breaks, restroom break, etc.), equipment faults (e.g., servo fault, cutter breakage, heating element breakage, etc.), equipment maintenance (e.g., refill product being deposited into pouches, refill film used to create pouches, cleaning, adjustments, etc.), and any other interruptions that the repetitive equipment is subject to. A manufacturing facility may incorrectly blame deviations from the optimal up time on equipment faults, with such deviations from the optimal up time actually being a result of any number of other possible interruptions, as discussed above. Thus, the inventors of this disclosure came to appreciate that a need exists with the art to be able to determine, document and/or quantify such interruptions and their causes.

Such repetitive machine apparatus performs a series of repetitive serial processes, with any individual process being dependent upon a previous process being completed before a next process can be performed. For example, a pouch cannot be sealed until the pouch is filled with product. The inventors of this disclosure also came to appreciate that as any of these processes slow over time for whatever reason from an optimal time, an optimal number of end products, e.g., filled pouches exiting the pouch machine, produced over a given period of time likewise slows. This slowing of production of end products can be a result of any number of such serial processes slowing, with typical repetitive machine apparatus not providing a way to determine what is actually slowing down production of the end products. Thus, the inventors of this disclosure also came to appreciate that a need exists with the art to be able to determine a source of such performance degradation for such repetitive machine apparatus.

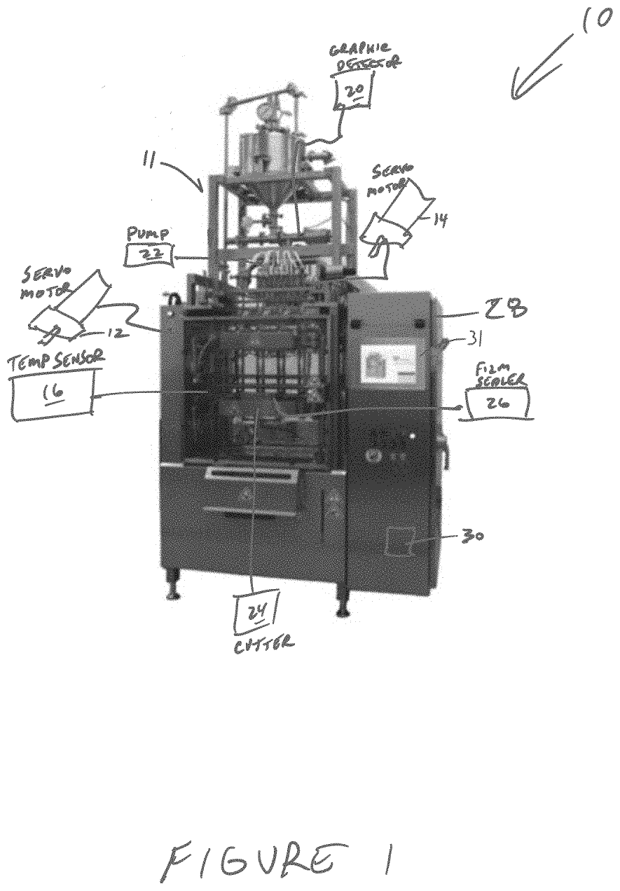

Referring now to the drawings and in particular to FIG. 1, a repetitive machine apparatus 10 is disclosed. The apparatus 10 can comprise a machine 11 that can manufacture one or more products from one or more input materials through the operation of repetitive, and often serial, mechanical, electromechanical, and/or thermomechanical processes. As an example of a machine, the machine 11 is shown as pouch machine which is a model W-18, Generation 3 Pouch Machine manufactured by Winpak Lane Inc. Although the machine 11 is illustrated as a pouch machine, and detailed examples below are provided within the context of such a pouch machine, one skilled in the art will appreciate that the mechanisms and processes disclosed herein can be applied to any apparatus comprising any machine that manufactures one or more products from one or more input materials through the operation of repetitive mechanical, electromechanical, and/or thermomechanical processes. In this example, the machine 11 is illustrated as including a variety of components including a first servo motor 12, a second servo motor 14, a temperature sensor 16, a graphic detector 20, such as for sensing the presence of graphical marks, such as trademarks, a filler pump 22, a cutter 24, and a film sealer 26, although one skilled in the art would appreciate that such a list is exemplary and that the exemplary machine 11 can include other or different components. For example, with the machine 11, implemented as the W-18, Generation 3 Pouch Machine, the film sealer 26 can include two (2) systems, one to seal sides of a pouch and one to seal a bottom, top of the pouch.

The number of servo motors disclosed herein is exemplary. A machine 11 can include more or less servo motors dependent upon the type of repetitive machine apparatus. For example, the machine 11 when implemented as the W-18, Generation 3 Pouch Machine can include four (4) servo motor driven axis of motion, with an option for a fifth (5^{th}). When referenced herein, the “servo motor” can include a servo motor, encoder, gear box and drive. The machine 11 can include a servo motor powered pull wheel drive system to index the film, a servo motor powered pump drive system, a servo motor powered pump rotor drive system. a servo motor powered cross seal/side seal overlock drive, and an optional code dater traverser drive system.

Back to FIG. 1, the first and second servo motors 12, 14 are of the type motor that can be used to provide very precisely controlled motion within the machine 11. For example, one of the first servo motor 12 and the second servo motor 14 can be used to control movement of input materials, such as film for the above-referenced pouch machine, through the machine 11 during manufacturing of the product. The first servo motor 12 can control rotation of a pull wheel (not shown), which in turn moves the film, for example, in the machine 11 while determining registration (graphic alignment) to an unfinished version of, for example, a pouch. The second servo motor 14 can control rotation of a rotary valve (not shown) of the filler pump 22. The second servo motor 14 works in conjunction with another servo motor (not shown) that controls piston motion of the filler pump 22. Together the first and second servo motors 12, 14 determine when a pouch, for example, is filled and a volume to be filled into the pouch.

The first and second servo motors 12, 14 receive control signals from a controller, such as the exemplary controller 28, which can also be part of the apparatus 10. The controller 28 provides control signals controlling the position, velocity and acceleration of the first and second servo motors 12, 14, as well as other aspects of the manufacturing parameters of the machine 11. The first and second servo motors 12, 14 provide servo feedback data, such as position data, acceleration data, and velocity data, including by providing such data to the controller 28. Although not shown, the machine 11 can further include at least one pneumatic actuator to facilitate motion within the machine, such as to move the cutter 24 while performing cutting of the film.

A temperature sensor, such as the temperature sensor 16, generates temperature information proportional to a temperature within a vicinity of the temperature sensor 16. For example, the temperature sensor 16 can be disposed within a vicinity of the film sealer 26. The temperature sensor 16 generates temperature information associated with a temperature of the film sealer 26. Such information can be provided, including to the controller 28. At least one of the first servo motor 12 and the second servo motor 14 can be coupled to the film sealer 26. The least one of the first servo motor 12 and the second servo motor 14 provide servo feedback data, such as to the controller 28, by which it can be determined whether the film sealer 26 is operating according to specifications thereof, such as based on position, velocity and acceleration data provided by the first servo motor 12 and the second servo motor 14.

Pouch machines typically have adjustments to control alignment of the film while traversing the pouch machine 11. The controller 28 can receive film alignment data to determine if the film is properly aligned within the pouch machine 11. Pouches typically include a graphic, including graphics that describe the contents of the pouch, as well as provide other visual information. The graphic detector 20 detects whether the graphic is aligned such that the graphic is disposed approximately centrally on the pouch without being cut-off, thereby generating graphic alignment data. The controller 28 can receive the graphic alignment data to determine if the graphic is properly aligned on the pouch.

The filler pump 22 pumps material into the pouch, such as, for example, ketchup, mustard, vinegar, mayonnaise, or any other material, into the pouch prior to the film sealer 26 sealing the pouch. The controller 28 generates pump control signals that the filler pump 22 receives to control pumping by the filler pump 22. The filler pump 22 generates feedback data, as discussed above, that the filler pump 22 can provide to the controller 28. In at least one configuration, the filler pump 22 is a system that includes a drive that moves pistons up and down, and a pump rotor that opens and closes to feed liquid through fill nozzles and into the pouch.

In addition to the above-described components, the apparatus 10 can further comprise a physical display device, such as the physical display device 31. The physical display device 31 can be in the form of a Liquid Crystal Display (LCD), cathode ray tube (CRT) display, Organic Light Emitting Diode (OLED) display or any other display technology that can visually present graphics and information to a user. The physical display device 31 can be mounted proximate to the machine 11. For example, the physical display device 31 can be integrated into a cabinet that can house the controller 28. In such an orientation, a control panel, providing control of one or more manufacturing parameters defining and operation of the machine 11, can include the physical display device 31. For example, the physical display device 31 can be a touchscreen display device that, in addition to outputting visual content, can also receive input, such as user touches directed to specific ones of the output visual content. The control panel, therefore, can be displayed on the physical display device 31 and the user can control the machine 11 through touches directed to specific visual content output by the physical display device 31.

The apparatus 10 can further comprise a computing device, such as a performance monitor computing device 30. The performance monitor computing device 30 can be physically located proximate to the controller 28 such that inputs and/or outputs received by or generated by the controller 28 can further be communicated to the performance monitor computing device 30. In such a manner, the performance monitor computing device 30 can be communicationally coupled with the machine 11, and can receive inputs from various components of the machine 11, such as those detailed above. Additionally, the performance monitor computing device 30 can be communicationally coupled to the physical display device 31, such as to be able to generate visual content on the physical display device 31.

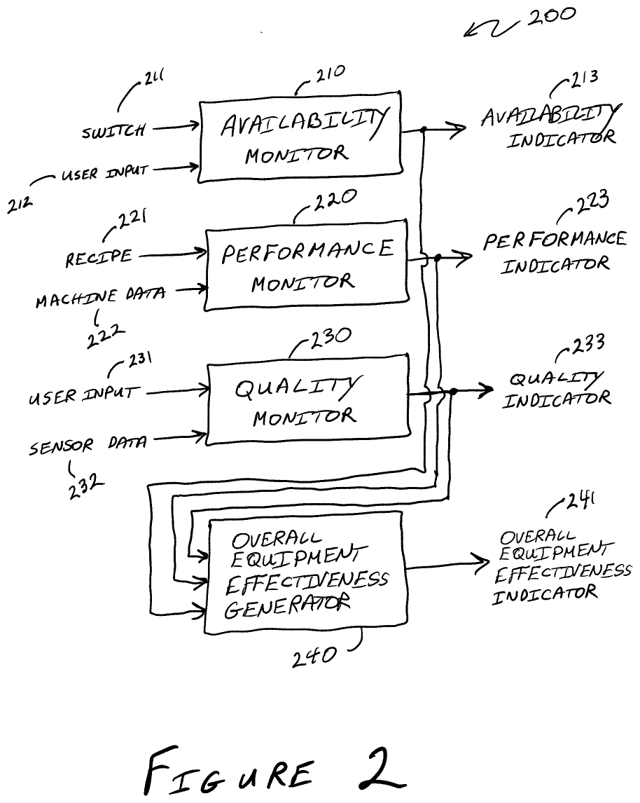

As indicated, the performance monitor computing device 30 can receive various types of data, in addition to the feedback data discussed above, from which the performance monitor computing device 30 can generate performance data associated with the machine 11. Turning to FIG. 2, an exemplary system 200 shown therein illustrates exemplary components that can be executed by the performance monitoring computing device 30 to monitor the performance of the machine 11. The exemplary system 200 includes an availability monitor 210, a performance monitor 220, a quality monitor 230 and an overall equipment effectiveness generator 240 that can receive information from the availability monitor 210, the performance monitor 220 and/or the quality monitor 230, and generate an overall equipment effectiveness indicator 241.

An availability monitor 210 can determine an availability of the machine 11 during a prior duration of time. For example, the availability monitor 210 can determine how often, and for how long, the machine 11 was non-operational during the prior duration of time. As will be detailed further below, the operation of the machine can be stopped for multiple different reasons, including reasons that implicate the design or operation of the machine, such as machine faults, part failures, or other like machine-related reasons. Additionally, the operation of the machine can be stopped due to operator-related reasons, for example the operator taking a bathroom break or lunch break, or there being a change in operators, such as during a shift change. Accordingly, it can be desirable to distinguish between machine-related reasons and operator-related reasons. For example, a manufacturer of the machine can defend the operation of the machine to a customer by pointing out that stoppage of the machine was due primarily to operator-related reasons and not due to any inherent mechanical functionality of the machine.

The availability monitor 210 can generate an availability indicator 213 that can correlate a quantity of time during which the machine was not operating to a quantity of time during which the machine was operating, or to a total quantity of time. For example, the availability indicator 213 can indicate an availability of approximately 92% if, over the prior 11 hours and 47 minutes the machine was operating for 10 hours and 48 minutes and was stopped for approximately 59 minutes. As can be seen, the availability of 92% can be determined by dividing the operational time of 10 hours and 48 minutes by the total time over which the availability percentage is being determined, namely 11 hours and 47 minutes in the present example. Other indicators of availability can likewise be utilized. For example, the availability indicator 213 can be a ratio of operational time to stopped time. In such an example, utilizing the above values, the availability indicator could be a ratio of 10.98:1.0. Other examples of availability indicators include ratios of stopped time to total time, operational time to total time, and other like ratios. Still other examples of availability indicators include the percentage of the total time that the machine was stopped or other like percentages.

To determine times when the machine is operational versus when the machine is stopped, input from the machine can be provided to the performance monitor computing device 30, and such input can be utilized as input data to the availability monitor process 210. For example, input 211 from the machine can be in the form of a state of a switch or a triggering of the switch that can control whether the machine is stopped or operating. Such input 211 can then be logged by the availability monitor 210 and, based on the times of the logged data indicating when the machine stopped and/or was restarted, the durations an availability can be determined, such as detailed above.

In some instances, as will be detailed further below, it can be desirable to detail a particular reason for which a machine was stopped. For example, as indicated above, it can be relevant to be able to distinguish between stoppage due to machine-related reasons versus stoppage due to operator-related reasons. Accordingly, the availability monitor process 210 can receive user input data, in the form of the user input 212, providing an indication of a reason for a stoppage. The user input 212 can be one of a predetermined set of reasons, in which case the availability monitor 210 can log a code correlated to one of the predetermined reasons, or can log stopped time differently depending upon whether the reason is indicative of a machine-related reason or an operator-related reason. The user input 212 can also be textual input that can be entered by a user, in which case the availability monitor 210 can log the entire textual input. Alternatively, or in addition, the availability monitor 210 can perform keyword searching on the textual input provided by the user and can log the stopped time differently depending upon the whether the user's textual input includes specific keywords, exclude specific keywords, or combinations thereof.

Another component executable by the performance monitoring computing device 30 is the performance monitor component 220. The performance monitor 220 can determine performance of the machine 11 during a prior duration of time. Various metrics can be utilized to quantify performance. For example, performance can be quantified by a quantity of output generated by the machine 11, a speed at which the machine 11 generates output, an accuracy at which the machine 11 generates output, or tracks a particular manufacturing parameter, or other like quantification of performance. Within the context of the above described pouch machine, one quantification of performance can be a speed at which the machine 11 manufacturers pouches, which can be expressed either in terms of output quantity per unit time or input quantity per unit time. For example, a pouch machine's performance can be quantified as generating 1000 pouches per minute, or, alternatively, as consuming 100 linear feet of an input material, such as the aforementioned film, per minute.

Initially, when the machine is installed and/or delivered to a machine customer, a setup can be performed, such as by a trained operator, including a trained operator who is employed by, or acts on behalf of the manufacturer of the machine. Such a setup can entail the specification of manufacturing parameters defining and operation of the machine. For example, in the case of the aforementioned pouch machine, such set up a can include a specification of the speed at which the machine will consume input film, a length of each pouch, an instant in time at which a sealer begins sealing the input film together to create a pouch, a subsequent instant in time at which the sealer terminates sealing the input film, an instant in time at which a knife blade activates to cut one pouch from another, an instant in time at which the knife blade retracts, and other like specifications of manufacturing parameters. Colloquially, the specification of relevant parameters is often referred to as a “recipe”. A single machine can have different recipes in order to generate different types of output. Within the specific example of a pouch machine, one recipe defines the operation of the machine when generating pouches filled with ketchup, while a different recipe defines the operation of the machine when generating pouches filled with mayonnaise. The differences between the recipes can take into account the differences in handling ketchup versus mayonnaise, for example.

The performance monitor 220 can receive as input a recipe 221 and machine data 222 and can compare the received machine data 222 to the recipe 221 in order to generate a performance indicator 223. For example, the performance indicator 223 can indicate a performance of the machine quantified based on a speed at which the machine generates an output product. A recipe can specify that the maximum speed of the machine can be 115 products per minute, with the other manufacturing parameters of the recipe being established accordingly. From the perspective of the performance monitor 220, the specification of 115 products per minute, in the recipe 221, can be treated as a maximum speed or a 100% performance.

In a manner analogous to the availability indicator 213 correlating a quantity of time during which the machine was not operating to a quantity of time during which the machine was operating, the performance indicator 223 can correlate an actual, measured performance of the machine during a prior duration of time to an optimal, or 100%, performance. For example, if the optimal performance is 115 products per minute, as specified by the recipe 221, and the machine data 222 indicates that the machine was operated at a rate of 110 products per minute for an hour, then over the preceding hour the performance monitor 220 can determine a performance indicator 223 that correlates the actual rate of 110 products per minute to the optimal rate of 115 products per minute and can determine that the performance of the machine was approximately 96% of optimal over the prior hour. Accordingly, in such an example, the performance monitor 220 can generate a performance indicator 223 that takes into account both the rate of operation of the machine, as a metric of performance, as well as the duration during which such a rate of operation occurred. The performance indicator 223, therefore, can be a product of both duration and a measured rate achieved during the duration. By way of another example, the performance monitor 220 can receive machine data 222 that indicates that the machine was operated at a rate of 110 products per minute for five hours and 15 minutes and was further operated at a rate of five products per minute for 45 minutes. By weighting the rate of 110 products per minute in accordance with the substantially longer time period, namely five hours and 15 minutes, and by weighting the rate of five products per minute in accordance with the substantially shorter time period during which such a reduced rate occurred, namely a mere 45 minutes, prior to amalgamating the two rates, the performance monitor 220 can generate a performance indicator that the performance of the machine was approximately 84% of optimal over the preceding six hours. While described as a percentage that is based on both how often, during the prior duration of time, the machine was operating at a suboptimal operation and further based on an amount of delta between the suboptimal operation and an optimal operation, the performance indicator 223 can be expressed as other percentages or ratios. For example, the performance indicator 223 can be expressed as a ratio of performance above a predetermined threshold to performance below the predetermined threshold, or vice versa. As another example the performance indicator can be expressed as a duration of time during which performance was above a predetermined threshold. Other like performance indicators can also be utilized.

As indicated previously, the actual, measured performance of the machine during a prior duration of time can be quantifiable by the performance monitor 220 from the machine data 222. Accordingly, the machine data 222 can be data received from servomotors, temperature sensors, counters, detectors, or other like components of the machine 11. As discussed above, the machine data 222 can include data from at least one of the temperature sensor 16, the graphic detector 20, and any other sensors that can be coupled to the machine 11. Additionally, the machine data 222 can include feedback data from any of the components of the machine 11, such as the first servo motor 12, the second servo motor 14, the filler pump 22, and any other components that make up pouch machine 11.

The performance monitoring computing device 30 can further execute a quality monitor process 230 that can generate a quality indicator 233 that can quantify a quality of the output product generated by the machine 11. For example, the quality monitor 230 can determine how much of the product being manufactured by the machine, whether quantified as individual units, or as linear quantities, was properly manufactured during a prior duration in time. For example, if the machine 11 manufactures a specific item, then the quality monitor 230 can determine how many individual units, or items, were properly manufactured. As another example, if the machine 11 manufactures a linear quantity item such as a film or plastic, then the quality monitor 230 can determine how much quantity was properly manufactured with the quantity being expressed in terms of a linear quantity, such as feet, volumetric quantity, such as Liters, weight quantity, such as pounds, or other like quantity enumerations.

To determine a quantity of properly manufactured output product, the quality monitor 230 can receive sensor data 232 from the machine 11. The sensor data 232 can include some or all of the information detailed above with reference to the machine data 222. Alternatively, or in addition, the sensor data 232 can be specific to output sensors that detect output quantities and/or defects in the output quantities. The quality monitor 230 can also receive user input, such as in the form of the user input 231, which can directly specify a particular output quantity, or can flag certain output quantities, otherwise determined the other sensor data 232, as being at least one of properly manufactured, or comprising manufacturing defects. The user input 231 can be received in a manner analogous to the receipt of the user input 212, such as, for example, through the physical display device 31 that can be a touchscreen, such as in the manner detailed above.

For example, the quality monitor 230 can receive sensor data 232 that 22,600 units were properly manufactured over the preceding 10 hours and that over the same amount of time 3300 units were defective or otherwise manufactured improperly. The quality monitor 230, as another example, can receive sensor data 232 that 25,900 units were manufactured over the preceding 10 hours, and can further receive user input 231 that 3300 of those units were found to be defective or otherwise manufactured improperly. In either case, the quality monitor 230 can generate a quality indicator 233 correlating the quantity of properly manufactured units to the total quantity of manufactured units, such as, for example, indicating that the machine 11 achieved and 87% quality over the preceding 10 hours. As can be seen, the quality of 87 percent can be determined by dividing the quantity of correctly manufactured units, namely 22,600 units, by the total quantity of manufactured units, namely 25,900 units, with each quantity being relevance to a predetermined preceding time period, or duration of time, such as the preceding 10 hours in the above example. Other indicators of quality can likewise be utilized. For example, the quality indicator 233 can be a ratio of properly manufactured units to improperly manufactured units. In such an example, utilizing the above values, the quality indicator could be a ratio of 6.84:1.0. Other examples of quality indicators include ratios of improperly manufactured units to total manufactured units, properly manufactured units to total manufactured units, and other like ratios. Still other examples of availability indicators include the percentage of the total manufactured units that were improperly manufactured, and other like percentages.

An overall equipment effectiveness generator component 240 can generate an overall equipment effectiveness indicator 241 based on the availability indicator 213, the performance indicator 223, the quality indicator 233, and/or combinations thereof, each of which can be independently provided as input to the overall equipment effectiveness generator 240 by the availability monitor 210, the performance monitor 220 and the quality monitor 230, such as in a manner illustrated by the system 200 shown in FIG. 2. The overall equipment effectiveness indicator 241 can be an amalgamation of the availability indicator 213, the performance indicator 223, the quality indicator 233, and/or combinations thereof, which amalgamation can be in the form of a multiplication or an addition. Alternatively at least one or more of the availability indicator 213, the performance indicator 223, the quality indicator 233, and/or combinations thereof can be weighted in accordance with weighting factors prior to being amalgamated. The resulting overall equipment effectiveness indicator 241 can be indicative of an overall equipment effectiveness and, as such, can be a basis for evaluation of the machine 11. Alternatively, or in addition, the overall equipment effectiveness indicator 241 can be a basis on which customer requests to return the machine can be approved or denied, can be a basis on which machine manufacturer liability can be triggered, or can be a basis for, or a factor influencing, other logistical, sales, and/or legal actions or the lack of availability thereof.

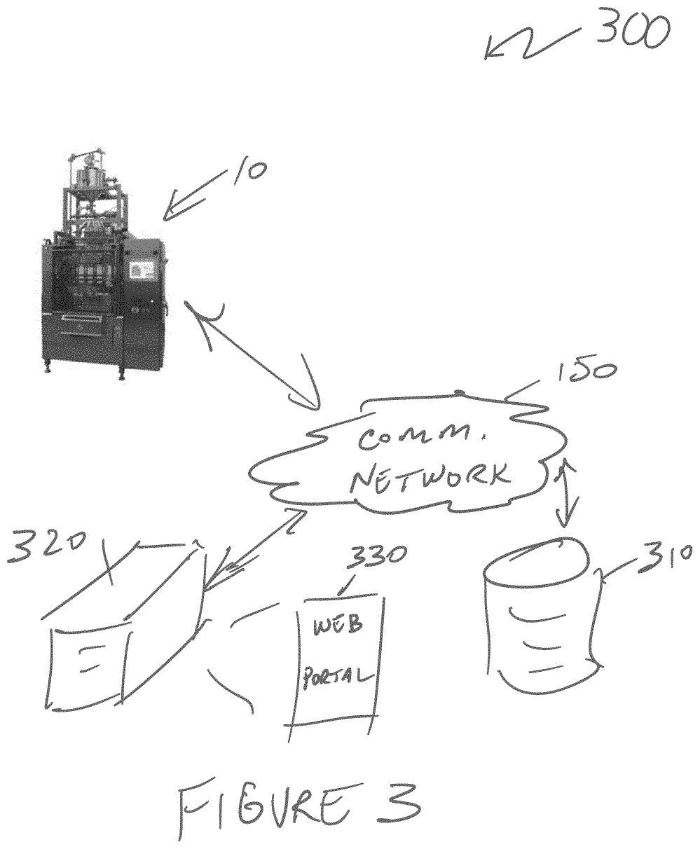

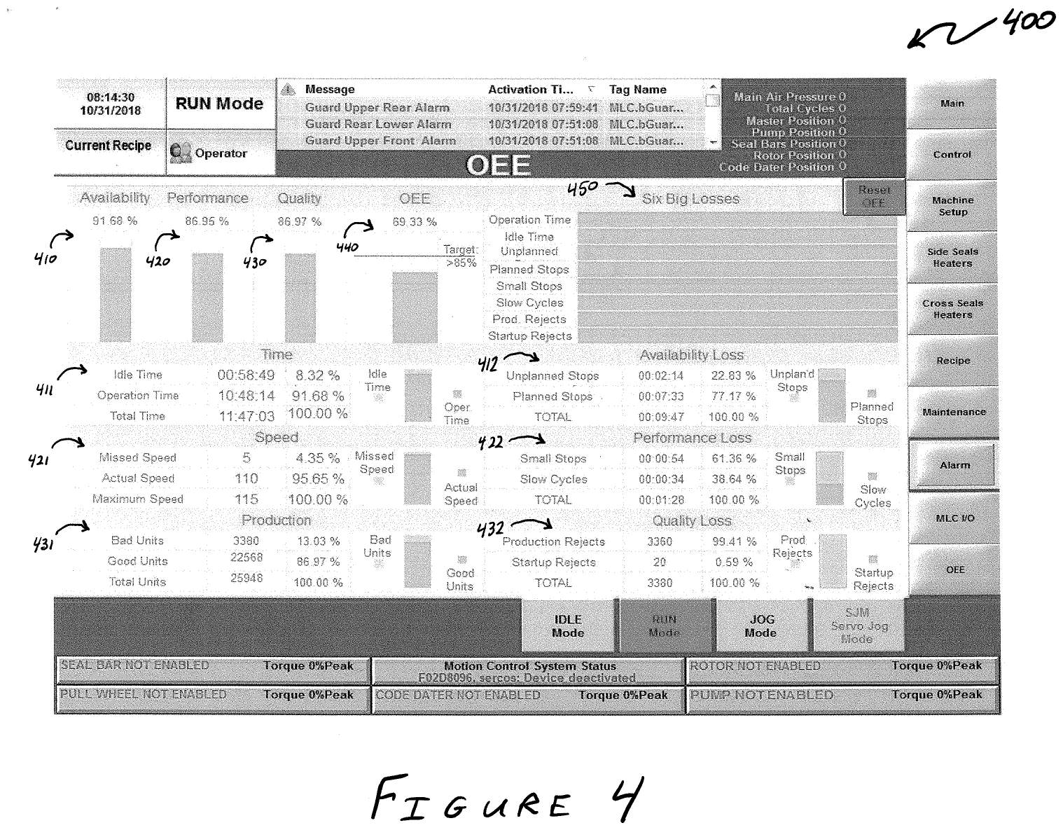

FIG. 3 illustrates a system 300 that includes the apparatus 10 shown in FIG. 1 and further including cloud storage server 310, a web hosting web server 320, and a communication network 150. As will be detailed below, the performance monitor computing device 30 generates a performance monitor GUI 400 (FIG. 4) that presents performance indicators of the machine 11. Such a performance monitor GUI 400 can be generated on the physical display device 31 (FIG. 1) of the apparatus 10 (FIG. 1). However, there could be instances where others other than the operator of the machine 11 may want to monitor performance of the machine 11. In such instances, the performance monitor computing device 30 transmits the performance data to the cloud storage server 310. The web server 320 can host a web portal 330 that allows another user to receive the performance data. For example, the performance monitor GUI 400 (FIG. 4) can be generated on a physical display device communicationally coupled to a computing device that can be communicationally coupled to the communication network 150, including, for example mobile computing devices and/or remote computing devices that are not physically proximate to the apparatus 10. The web server 320 can access the cloud storage server 310 to retrieve the performance data generated by the performance monitor computing device 30 and provide the performance analytics via the web portal 330.

Turning to FIG. 4, an exemplary performance monitor graphical user interface, in the form of the performance monitor GUI 400 is illustrated. The performance monitor GUI 400 includes a first portion 410 that comprises an availability indicator, the availability indicator graphically illustrating an availability of the machine 11, determined such as in the manner detailed above with reference to the availability monitor process 210 (FIG. 2). The performance monitor GUI 400 further includes a second portion 420 that comprises a performance indicator, the performance indicator graphically illustrating a performance of the machine 11, determined such as in the manner detailed above with reference to the performance monitor process 220 (FIG. 2). The performance monitor GUI 400 also includes a third portion 430 that comprises a quality indicator, the quality indicator graphically illustrating a quality of manufactured output of the machine 11, determined such as in the manner detailed above with reference to the quality monitor process 230 (FIG. 2).

In the exemplary performance monitor GUI 400, the availability, performance and quality indicators are illustrated as bar graphs. However, the availability, performance and quality indicators can equally be other types of graphs, charts, textual content or other like visual representations that graphically illustrate the availability, performance and quality of the machine 11, such as determined in the manner detailed above. Additionally, while the exemplary performance monitor GUI 400 is a static image, the first portion 410, second portion 420 and third portion 430 can comprise animated and/or dynamic images, graphs, textual content, or the like. For example, the first portion 410 can comprise an animated availability indicator that can increase or decrease in a real-time manner. As another example, the first portion 410 can comprise an animated availability indicator that can visually expand until an indicated availability is reached so as to provide a more visually pleasing user interface.

The performance monitor GUI 400 can further comprise a fourth portion 440 that can comprise an overall equipment effectiveness indicator, which can be determined such as in the manner detailed above. As with the portions 410, 420 and 430, the fourth portion 440 can include graphics and/or text and can be static and/or animated.

Optionally, each of the availability, performance and quality metrics can be further broken down and displayed within the performance monitor GUI 400. For example, a portion 411 can quantify various periods of time to further elucidate the availability metrics displayed within the portion 410. Likewise, a portion 412 can quantify various different reasons or categories of machine availability, or lack thereof, to, likewise, further elucidate the availability metrics displayed within the portion 410. As for the performance metrics displayed within the portion 420, performance quantification can be in terms of, for example, speed, which can be quantified in the portion 421, types of performance loss, which can be quantified in the portion 422, or other like details, which can be displayed in one or more of the portions for 421 and/or 422, or still further portions of the performance monitor GUI 400. The quality metrics displayed within the portion 430 can be further quantified in terms of quantities of units that were, and/or were not, manufactured properly, which can be displayed in the portion 431, as well as a categorization of rejected units, which can be displayed in the portion 432.

Other information that may of interest to an operator of the machine 11, or a manufacturer thereof, includes specific enumeration of pre-determined factors, such as various metrics on which the operator and/or manufacturer may wish to focus. Accordingly, the performance monitor GUI 400 can include a portion 450 where such specific factors can be quantified or metrics corresponding thereto can be displayed.

As indicated previously, the performance metrics determined by the performance monitoring computing device 30 (FIG. 1) and displayed by the performance monitor GUI 400 (FIG. 4) can be beneficial for identifying whether an operation of the machine below optimal thresholds is due to some defect or problem with the machine itself, which can negatively impact the machine's manufacturer or whether it is due to the manner in which the machine is being operated by a customer and/or operator hired by the customer of the machine, in which case the machine's manufacturer can be vindicated or otherwise avoid liability and/or negativity. Accordingly, it can be desirable to detail why a machine is stopped or is otherwise rendered nonoperational by an operator or customer of the machine. For example, if the operator stopped the machine because the machine was improperly manufacturing a product, or was spilling a product, or otherwise malfunctioning, then such a stoppage, and the corresponding suboptimality, is attributable to the machine's manufacturer. By contrast, if the operator stopped the machine because they wanted to take a smoke break, or an extended lunch, then the corresponding suboptimality is not properly attributable to the machine's manufacturer but rather is attributable to an inefficient utilization of the machine by the customer and/or operator hired on behalf of the customer of the machine.

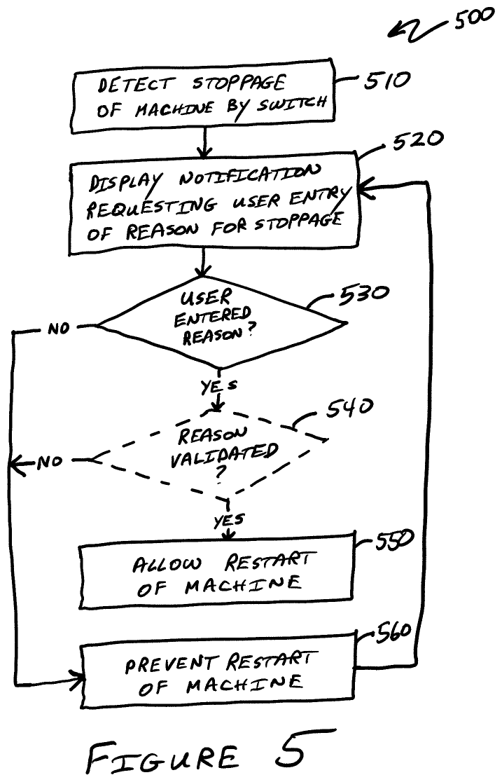

To enforce the recordation of detail as to why a machine is stopped, control of the machine, such as provided through a control panel, touchscreen, computing device, or other controller, including those detailed above, can execute computer-executable instructions directed to causing the computing device to perform the steps of the flow diagram 500 shown in FIG. 5, or can otherwise perform such steps. Initially, at step 510, as shown in FIG. 5, stoppage of the machine can be detected. As indicated previously, the machine can comprise a switch through which operation of the machine can be stopped. Accordingly, step 510 can be performed by detecting an activation of such a switch. Subsequently, at step 520, a notification can be displayed to a user or operator of the machine, such as through a physical display device positioned proximate to the machine, and the notification can request that the user or operator enter a reason for the stoppage. As will be detailed further below, such a reason can be selected from a predetermined list of reasons, which can be displayed on the physical display device such that a user can enter such a reason by, for example, touching in an appropriate area of a touchscreen display device. Alternatively, or in addition, such a reason can be open ended and the user can be prompted to enter textual content to detail the reason.

At step 530 a determination can be made as to whether the user has entered a reason. If, at step 530, it is determined that the user has not yet entered a reason, then processing can proceed to step 560 and a restarting of the machine, such as through a switch, which can be the same switch utilized to stop the machine, or a corresponding switch, or through other like restarting activations, can be prevented. Step 560, therefore, can enforce the entry of the reason for the stoppage, and can prevent restarting of the machine until a reason is specified. By contrast, if, at step 530, it is determined that the user has entered a reason, step 550 can be executed and the machine can be allowed to restart upon the user activating the appropriate switch or other like restarting activation.

Optionally, as illustrated by the dashed lines, step 540 can be performed upon receipt of a user-entered reason at step 530. More specifically, at step 540, the received reason can be validated. For example, if the user selected from one of a predetermined list of reasons, corresponding sensors or other like machine data can be polled to verify the stated reason. For example, if the user selected a reason indicating that a roll of film needed to be changed, then sensors or other like machine components associated with the role of film can be polled to verify that the role of film does, indeed, need to be changed. If such sensors, or other like machine components, indicate that the role of film was not changed and/or does not need to be changed, then, at step 540, the reason can be found to be invalid, and restart of the machine can be prevented at step 560 until a valid reason, as validated by step 540, is entered. In such a manner, falsified entries can be minimized or avoided entirely. For example, an operator who wishes to take an unauthorized break may seek to input a false reason for stoppage of the machine to avoid detection of the unauthorized break. However, such a false reason can negatively reflect upon the machine's manufacturer. Accordingly, it can be beneficial to minimize or avoid falsified entries. In instances where user textual entry is received, validation of the reason at step 540 can be based on keyword analysis, artificial intelligence, or other like computerized parsing of user input text representing language input.

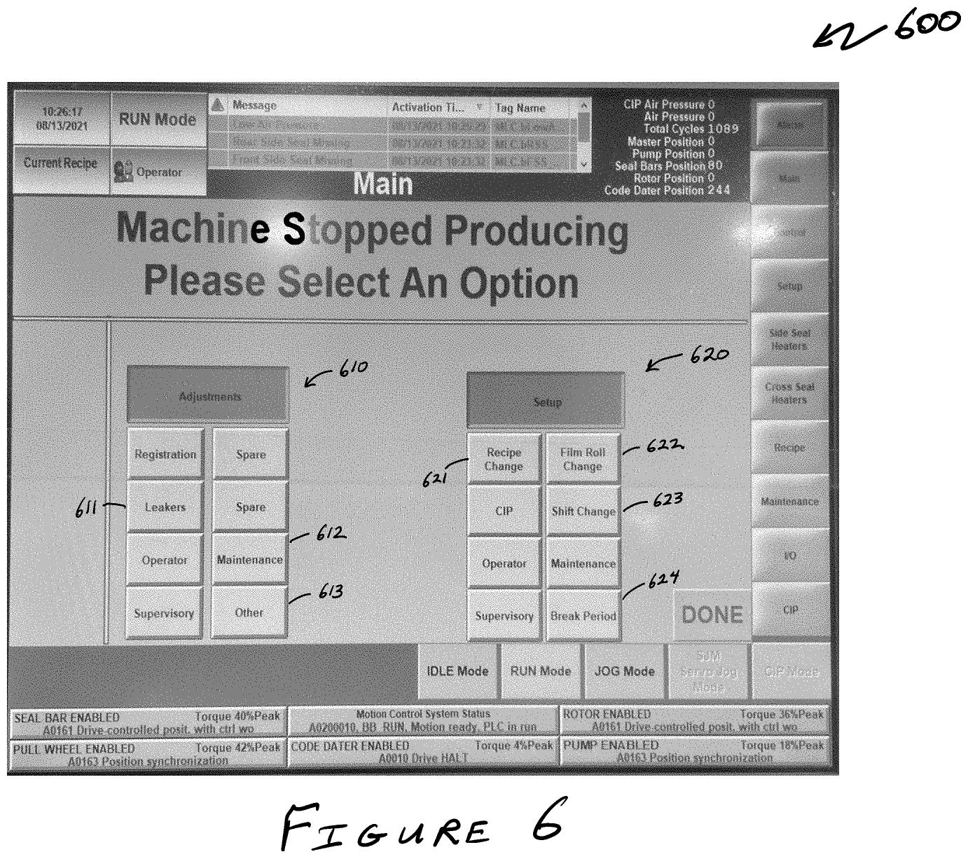

FIG. 6 illustrates an exemplary stop GUI 600 showing a list of options for an operator to select from when the machine is stopped by the operator. The stop GUI 600 can include a list of options that can be further categorized or divided into subcategories for easier selection by the operator. For example, the stop GUI 600 comprises a first portion 610 having reasons for stoppage that are related to adjustments of the machine. Within such a first portion 610, individual reasons are enumerated, such as the “Leakers” reason 611 and the “Maintenance” reason. As indicated previously, in addition to specific, predetermined reasons, open-ended input can be accepted. Accordingly, the first portion 610 comprises an “Other” selection 613, whereby the operator can be provided with a mechanism by which textual language entry can be accepted.

As another example, the stop GUI 600 also comprises a second portion 620 having reasons for stoppage that are related to set up of the machine. Within such a second portion 620 individual reasons, such as “Recipe Change” 621, “Film Roll Change” 622, “Shift Change” 623 and “Break Period” 624 are enumerated. Depending upon the reason selected, the stoppage of the machine may be categorized differently, such as by the performance monitor 220. For example, selection of the “Shift Change” 623 or “Break Period” 624 reasons can result in the stoppage of the machine being treated as a planned stop, or otherwise identified as a stoppage of the machine that is operator-related. Such a planned stop can be excluded from, for example, the availability indicator 213, since it is not machine-related. By contrast, selection of the “Recipe Change” 621 or “Film Roll Change” 622 reasons, for example, can result in the stoppage of the machine being treated as an unplanned stop or otherwise identify the stoppage as being machine-related. The stoppage can then be included within the availability indicator 213, such as detailed above.

As indicated above, an operator of the machine may seek to falsely select, for example, the “Film Roll Change” reason 622 because the operator has already exceeded their allotted break time and is therefore, reluctant, to accurately select the “Break Period” reason 624. Accordingly, should the “Film Roll Change” reason 622 be selected, verification can be made that the film role does, indeed, need to be changed, such as by polling sensors that detect a quantity of film left on the roll, servos that feed the film roll, or other like components of the machine. If the “Film Roll Change” reason 622 is not verified, then restarting of the machine can be prevented until a verifiable reason is selected, such as the accurate “Break Period” reason 624 in the present example.

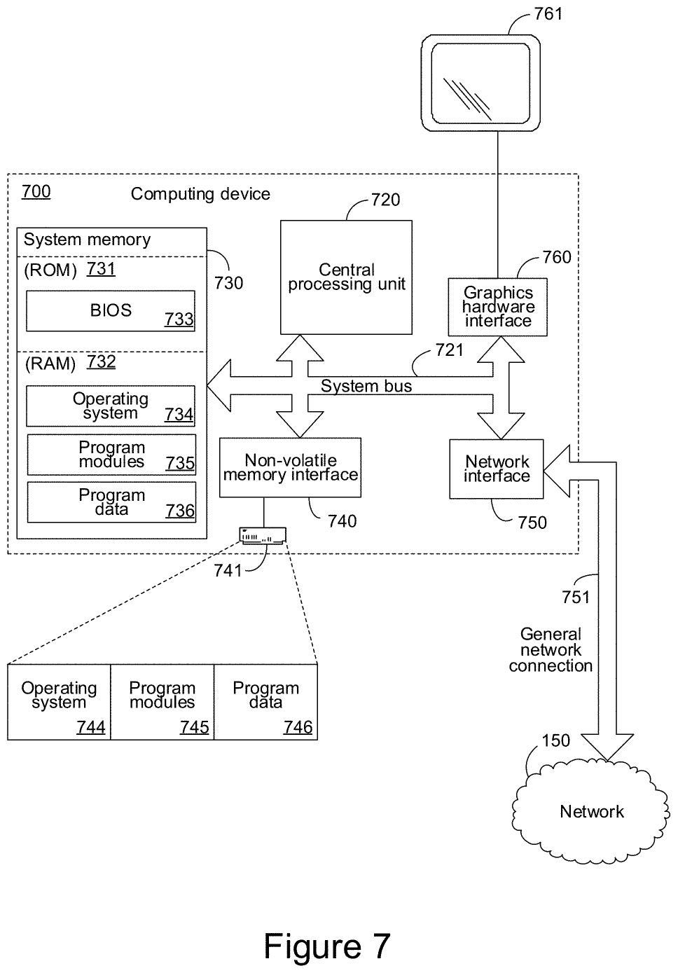

Turning to FIG. 7, an exemplary computing device 700 is illustrated which can perform some or all of the mechanisms and actions described above. The exemplary computing device 700 includes, but is not limited to, one or more central processing units (CPUs) 720, a system memory 730, and a system bus 721 that couples various system components including the system memory to the processing unit 720. The system bus 721 may be any of several types of bus structures including a memory bus or memory controller, a peripheral bus, and a local bus using any of a variety of bus architectures. The computing device 700 can optionally include graphics hardware, including, but not limited to, a graphics hardware interface 760 and a display device 761, which includes display devices capable of receiving touch-based user input, such as a touch-sensitive, or multi-touch capable, display device. Depending on the specific physical implementation, one or more of the CPUs 720, the system memory 730 and other components of the computing device 700 can be physically co-located, such as on a single chip. In such a case, some or all of the system bus 721 can be nothing more than silicon pathways within a single chip structure and its illustration in FIG. 7 can be nothing more than notational convenience for the purpose of illustration.

The computing device 700 also typically includes computer readable media, which includes any available media that can be accessed by computing device 700 and includes both volatile and nonvolatile media and removable and non-removable media. By way of example, and not limitation, computer readable media may comprise computer storage media and communication media. Computer storage media includes media implemented in any method or technology for storage of content such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired content and which can be accessed by the computing device 700. Computer storage media, however, does not include communication media. Communication media typically embodies computer readable instructions, data structures, program modules or other data in a modulated data signal such as a carrier wave or other transport mechanism and includes any content delivery media. By way of example, and not limitation, communication media includes wired media such as a wired network or direct-wired connection, and wireless media such as acoustic, RF, infrared and other wireless media. Combinations of the any of the above should also be included within the scope of computer readable media.

The system memory 730 includes computer storage media in the form of volatile and/or nonvolatile memory such as read only memory (ROM) 731 and random access memory (RAM) 732. A basic input/output system 733 (BIOS), containing the basic routines that help to transfer content between elements within computing device 700, such as during start-up, is typically stored in ROM 731. RAM 732 typically contains data and/or program modules that are immediately accessible to and/or presently being operated on by processing unit 720. By way of example, and not limitation, FIG. 7 illustrates operating system 734, other program modules 735, and program data 736.

The computing device 700 may also include other removable/non-removable, volatile/nonvolatile computer storage media. By way of example only, FIG. 7 illustrates a hard disk drive 741 that reads from or writes to non-removable, nonvolatile magnetic media. Other removable/non-removable, volatile/nonvolatile computer storage media that can be used with the exemplary computing device include, but are not limited to, magnetic tape cassettes, flash memory cards, digital versatile disks, digital video tape, solid state RAM, solid state ROM, and other computer storage media as defined and delineated above. The hard disk drive 741 is typically connected to the system bus 721 through a non-volatile memory interface such as interface 740.

The drives and their associated computer storage media discussed above and illustrated in FIG. 7, provide storage of computer readable instructions, data structures, program modules and other data for the computing device 700. In FIG. 7, for example, hard disk drive 741 is illustrated as storing operating system 744, other program modules 745, and program data 746. Note that these components can either be the same as or different from operating system 734, other program modules 735 and program data 736. Operating system 744, other program modules 745 and program data 746 are given different numbers hereto illustrate that, at a minimum, they are different copies.

The computing device 700 may operate in a networked environment using logical connections to one or more remote computers. The computing device 700 is illustrated as being connected to the general network connection 751 (to a network 150, such as that shown in FIG. 3) through a network interface or adapter 750, which is, in turn, connected to the system bus 721. In a networked environment, program modules depicted relative to the computing device 700, or portions or peripherals thereof, may be stored in the memory of one or more other computing devices that are communicatively coupled to the computing device 700 through the general network connection 771. It will be appreciated that the network connections shown are exemplary and other means of establishing a communications link between computing devices may be used.

Although described as a single physical device, the exemplary computing device 700 can be a virtual computing device, in which case the functionality of the above-described physical components, such as the CPU 720, the system memory 730, the network interface 760, and other like components can be provided by computer-executable instructions. Such computer-executable instructions can execute on a single physical computing device, or can be distributed across multiple physical computing devices, including being distributed across multiple physical computing devices in a dynamic manner such that the specific, physical computing devices hosting such computer-executable instructions can dynamically change over time depending upon need an availability. In the situation where the exemplary computing device 700 is a virtualized device, the underlying physical computing devices hosting such a virtualized computing device can, themselves, comprise physical components analogous to those described above, and operating in a like manner. Furthermore, virtual computing devices can be utilized in multiple layers with one virtual computing device executing within the construct of another virtual computing device. The term “computing device”, therefore, as utilized herein, means either a physical computing device or a virtualized computing environment, including a virtual computing device, within which computer-executable instructions can be executed in a manner consistent with their execution by a physical computing device. Similarly, terms referring to physical components of the computing device, as utilized herein, mean either those physical components or virtualizations thereof performing the same or equivalent functions.

The foregoing description merely explains and illustrates the disclosure and the disclosure is not limited thereto except insofar as the appended claims are so limited, as those skilled in the art who have the disclosure before them will be able to make modifications without departing from the scope of the disclosure.

What is claimed is:

1. An apparatus comprising:
a machine for manufacturing a product from one or more input materials, the machine comprising:
a first sensor detecting a first aspect of the manufacturing of the product by the machine utilizing the one or more input materials;
a control panel providing control of one or more manufacturing parameters defining an operation of the machine; and
a switch thru which the operation of the machine can be stopped;
a physical display device; and
a computing device communicationally coupled to both the machine and the physical display device, the computing device comprising:
one or more processing units; and
one or more computer-readable storage media storing computer-executable instructions, which, when executed by at least some of the one or more processing units, cause the computing device to generate, on the physical display device, a user interface comprising:
a first portion comprising an availability indicator, the availability indicator graphically illustrating how often, during a prior duration of time, the machine was stopped;
a second portion comprising a performance indicator, the performance indicator graphically illustrating both: (1) how often, during the prior duration of time, the machine was operating at a suboptimal operation and (2) a delta between the suboptimal operation and an optimal operation; and
a third portion comprising a quality indicator, the quality indicator graphically illustrating how much of the product were properly manufactured by the machine during the prior duration of time.

2. The apparatus of claim 1, wherein the availability indicator is a graph of an availability percentage, the availability percentage being at least one of: a percentage of the prior duration of time during which the machine was stopped or a percentage of the prior duration of time during which the machine was operational.

3. The apparatus of claim 1, wherein the performance indicator is a graph of a performance percentage, the performance percentage being based on a percentage of the prior duration of time during which the machine was operating at the suboptimal operation multiplied by a percentage of the optimal operation that was the suboptimal operation.

4. The apparatus of claim 1, wherein the optimal operation of the machine is defined by a predetermined recipe specifying at least some of the one or more manufacturing parameters.

5. The apparatus of claim 1, wherein the quality indicator is a graph of a quality percentage, the quality percentage being at least one of: a percentage of a total quantity of the product manufactured by the machine during the prior duration of time that was properly manufactured or a percentage of a total quantity of the product manufactured by the machine during the prior duration of time that contained a defect.

6. The apparatus of claim 5, wherein a determination that the product manufactured by the machine during the prior duration of time contained the defect was automatically performed by the computing device based on an output of the first sensor.

7. The apparatus of claim 1, wherein the user interface further comprises:
a fourth portion comprising an overall equipment effectiveness indicator, the overall equipment effectiveness indicator graphically illustrating an amalgamation of the availability indicator, the performance indicator and the quality indicator.

8. The apparatus of claim 8, wherein the overall equipment effectiveness indicator is a graph of an overall equipment effectiveness percentage, the overall equipment effectiveness percentage being based on a multiplication of the availability indicator, the performance indicator and the quality indicator.

9. The apparatus of claim 1, wherein the one or more computer-readable storage media store further computer-executable instructions, which, when executed by at least some of the one or more processing units, cause the computing device to:
detect a stoppage of the machine via the switch;
generate, on the physical display device, a notification requesting that a user enter a reason for the stoppage; and
preventing a restarting of the machine via the switch until the user enters the reason for the stoppage.

10. The apparatus of claim 9, wherein the one or more computer-readable storage media store further computer-executable instructions, which, when executed by at least some of the one or more processing units, cause the computing device to:
validate the reason for the stoppage, as entered by the user, based on output of the first sensor; and
continue to prevent the restarting of the machine via the switch if the reason is not validated.

11. The apparatus of claim 9, wherein the user interface comprises a fourth portion comprising at least one of: a correlation between the availability indicator and the reason for the stoppage or a correlation between the performance indicator and the reason for the stoppage.

12. A graphical user interface, physically generated on a physical display device by a computing device that is communicationally coupled to the physical display device, the graphical user interface comprising:
a first portion comprising an availability indicator, the availability indicator graphically illustrating how often, during a prior duration of time, the machine was stopped;
a second portion comprising a performance indicator, the performance indicator graphically illustrating both: (1) how often, during the prior duration of time, the machine was operating at a suboptimal operation and (2) a delta between the suboptimal operation and an optimal operation; and
a third portion comprising a quality indicator, the quality indicator graphically illustrating how many of the product were properly manufactured by the machine during the prior duration of time.

13. The graphical user interface of claim 12, wherein the availability indicator is a graph of an availability percentage, the availability percentage being at least one of: a percentage of the prior duration of time during which the machine was stopped or a percentage of the prior duration of time during which the machine was operational.

14. The graphical user interface of claim 12, wherein the performance indicator is a graph of a performance percentage, the performance percentage being based on a percentage of the prior duration of time during which the machine was operating at the suboptimal operation multiplied by a percentage of the optimal operation that was the suboptimal operation.

15. The graphical user interface of claim 12, wherein the optimal operation of the machine is defined by a predetermined recipe specifying at least some of the one or more manufacturing parameters.

16. The graphical user interface of claim 12, wherein the quality indicator is a graph of a quality percentage, the quality percentage being at least one of: a percentage of a total quantity of the product manufactured by the machine during the prior duration of time that was properly manufactured or a percentage of a total quantity of the product manufactured by the machine during the prior duration of time that contained a defect.

17. The graphical user interface of claim 12, wherein the user interface further comprises:
a fourth portion comprising an overall equipment effectiveness indicator, the overall equipment effectiveness indicator graphically illustrating an amalgamation of the availability indicator, the performance indicator and the quality indicator.

18. The graphical user interface of claim 18, wherein the overall equipment effectiveness indicator is a graph of an overall equipment effectiveness percentage, the overall equipment effectiveness percentage being based on a multiplication of the availability indicator, the performance indicator and the quality indicator.

19. A method of controlling a machine for manufacturing a product from one or more input materials, the machine comprising a switch thru which the operation of the machine can be stopped, the method comprising:
detecting, by a computing device communicationally coupled to the machine, a stoppage of the machine via the switch;
physically generating, by the computing device, on a physical display device communicationally coupled to the computing device, a notification requesting that a user enter a reason for the stoppage; and
preventing, by the computing device, a restarting of the machine via the switch until the user enters the reason for the stoppage.

20. The method of claim 19, further comprising:
validating, by the computing device, the reason for the stoppage, as entered by the user, based on output of a first sensor, the machine comprising the first sensor; and
continuing to prevent, by the computing device, the restarting of the machine via the switch if the reason is not validated.
